(19) United States
(12) Patent Application Publication
(10) Pub. No.: US 2003/0185206 A1
(43) Pub. Date: Oct. 2, 2003

(54) Destination device bit map for delivering an information packet through a switch fabric

(76) Inventor: Bhaskar Jayakrishnan, Cooke Town (IN)

Correspondence Address: BUCKLEY, MASCHOFF, TALWALKAR, & ALLISON, 5 ELM STREET, NEW CANAAN, CT, 06840, US

(21) Appl. No.: 10/112,190

(22) Filed: Mar. 29, 2002

(51) Int. Cl. H04L 12/28

(52) U.S. Cl. 370/389; 370/252

(57) ABSTRACT

Some embodiments facilitate delivery of information packets through a switch fabric that includes a plurality of devices.

### BACKGROUND

In general, networks let entities communicate with each other. For example, a Personal Computer (PC) may receive text, audio, and/or image information from a Web server through a network. Similarly, executable information can be distributed via a network. For example, a new application or an update to a virus definition list may be distributed to a large number of entities through a network.

A network may include a number of interconnected hardware devices and associated software known as a switch fabric. The switch fabric may arrange for packets of information to be exchanged between devices within the switch fabric as well as to entities that are communicating through switch fabric. For example, packets of information may be exchanged in accordance with the Fast Ethernet Local Area Network (LAN) transmission standard 802.3-2002® published by the Institute of Electrical and Electronics Engineers (IEEE).

The switch fabric may include an edge device, such as a switch with a number of ports that can be connected to entities. Note that a single edge device might be connected to a number of entities, and that several edge devices can be included in a single switch fabric. A switch fabric might also include one or more crossbar devices that let edge devices exchange information with each other. Note that a single device might provide both edge device and crossbar device functionality.

By way of example, consider a switch fabric that includes a crossbar device connected to two edge devices. When a first PC connected to the first edge device wants to transmit information to a second PC connected to the second edge device, an information packet may be sent from the first edge device to the crossbar device. The crossbar device then forwards the information packet to the second edge device.

To facilitate the delivery of information packets through a switch fabric, a header attached to the information packet can include an address tag that is used to forward the information packet to the appropriate devices in the switch fabric (e.g., to edge devices and/or crossbar devices). As another approach, the header can include a device or entity identifier that is used to forward the information packet.

In either case, a header may need to be analyzed by a crossbar device in order to determine which edge devices and/or other crossbar devices should receive an associated information packet. For example, a crossbar device might examine an address tag and translate the tag into a port that will be used to transmit the information packet.

Such a technique, however, can require complex switch fabric management logic and large storage requirements—especially when the switch fabric topology includes multiple layers of crossbar devices and a large number of entities. The complexity of this logic can reduce the speed at which information packets can be exchanged within the switch fabric and/or reduce the amount of traffic that can be handled by the network.

### BRIEF DESCRIPTION OF THE DRAWINGS

FIG. 1 is a block diagram of a network according to some embodiments.

FIG. 2 illustrates an information packet and associated address information according to some embodiments.

FIG. 3 is a block diagram of a switch fabric according to another embodiment.

FIG. 4 illustrates address information according to the embodiment shown in FIG. 3.

FIG. 5 is a flow chart of a method to generate address information in an edge device according to some embodiments.

FIG. 6 is a block diagram of an edge device according to some embodiments.

FIG. 7 is a flow chart of a method to provide information packets according to some embodiments.

FIG. 8 is a block diagram of a crossbar device according to some embodiments.

FIG. 9 illustrates a configuration matrix according to some embodiments.

FIG. 10 is a flow chart of a method to adjust address information according to some embodiments.

FIG. 11 illustrates a switch fabric topology in accordance with some embodiments.

FIG. 12 is a flow chart of a method to select a port according to some embodiments.

FIGS. 13 and 14 illustrate a configuration matrix and port selection according to some embodiments.

### DETAILED DESCRIPTION

Some of the described embodiments are associated with a network “switch fabric.” As used herein, the phrase “switch fabric” may refer to any hardware and/or software that lets entities exchange information through a network. The switch fabric may include, for example, a number of edge devices and crossbar devices adapted to exchange information associated with a Fast Ethernet network.

Switch Fabric and Address Information

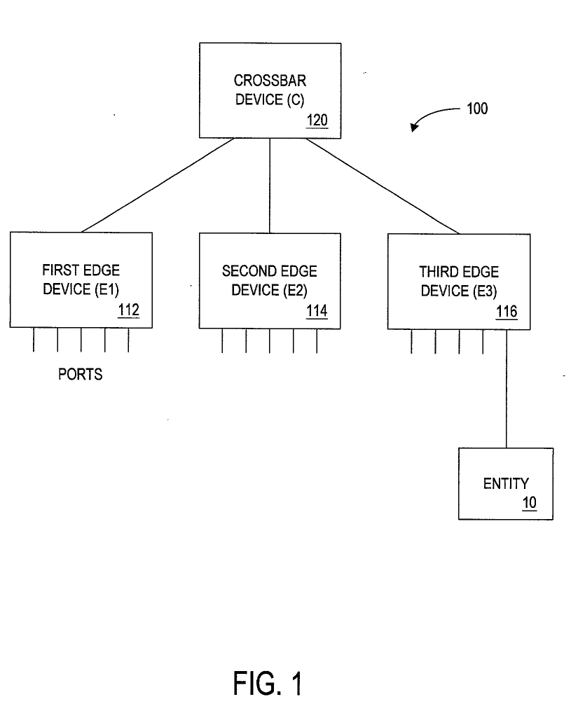

Turning now in detail to the drawings, FIG. 1 is a block diagram of a network 100 according to some embodiments. The network 100 may be associated with, for example, a LAN, a Virtual LAN (VLAN), a Metropolitan Area Network (MAN), a Wide Area Network (WAN), a Fast Ethernet network, a wireless network, a fiber network, and/or an Internet Protocol (IP) network, such as an intranet or an extranet. Note that the network 100 may be associated with any of a number of topologies, including multi-level, stacked, and/or star-wired topologies.

The network 100 may include a number of addressable entities 10 that are coupled to edge devices 112, 114, 116 via ports. The entities 10 may be, for example, PCs or servers. Each edge device is also coupled to a crossbar device 120 (“C”) that lets the edge devices exchange information with each other. For example, the entity 10 that is connected to the third edge device 116 (“E3”) might transmit information through the network 100 to a second entity that is connected to the first edge device 112 (“E1”). In this case, E3 would transmit an information packet to C, which in turn would forward the information packet to E1 for eventual delivery to the second entity.

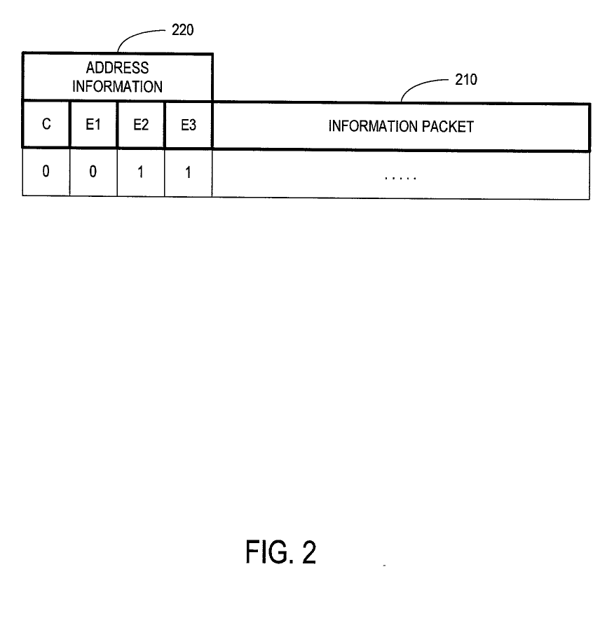

FIG. 2 illustrates an information packet 210 and associated address information 220 according to some embodiments. The information packet 210 and address information 220 might, for example, be sent from E1 to C in FIG. 1.

As can be seen, the address information 220 includes a separate indication for each of the four devices illustrated in FIG. 1 (i.e., C, E1, E2, and E3). In particular, the address information 220 is a destination device bit map that reflects which of the four devices should receive the associated information packet (e.g., a “1” may indicate that the device should receive the information packet 210 and a “0” may indicate that the device should not receive the information packet 210). That is, the address information “0011” indicates that the information packet should be delivered to E2 and E3 (but not to C or E1).

The address information 220 may be added to the information packet 210 as a header. Note that the header may also include other information not illustrated in FIG. 2 (e.g., information associated with multipoint link aggregation). Moreover, instead of being added as a header, the address information 220 might be added to the information packet 210 in a number of other ways. For example, the address information 229 might be added to the information packet 210 at a predetermined offset or position. Also note that the address information 220 might not include an indication for each and every device in the switch fabric. For example, the address information 220 illustrated in FIG. 2 might instead have indications for only E1, E2, and E3 (and not for C).

The destination device bit map may be used in connection with single-level or multi-level crossbar topologies to reduce the complexity of switch fabric management. For example, a crossbar device might simply interpret the address information 220 as a multicast address. Note that the destination device bit map approach can take advantage of a relatively limited number of nodes in a network (e.g., thirty two nodes).

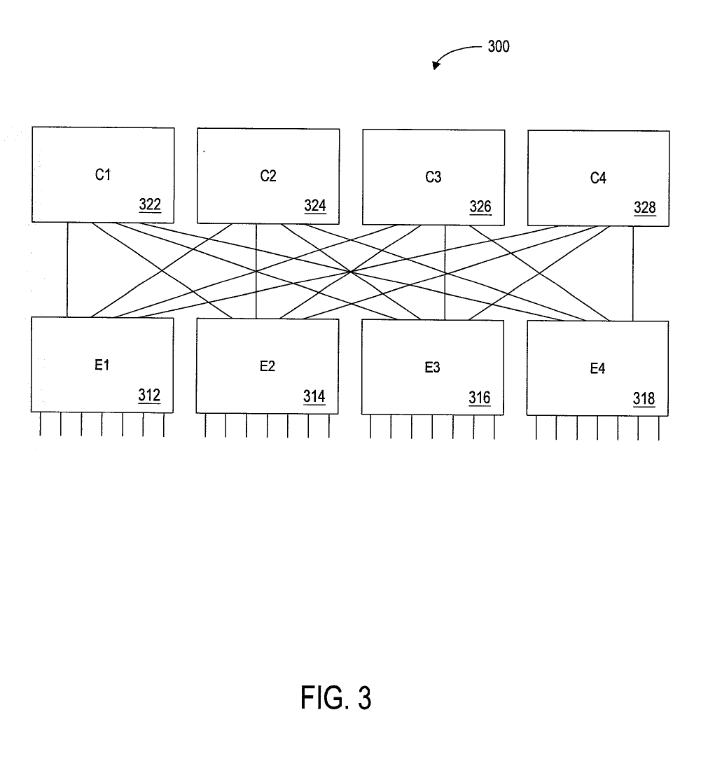

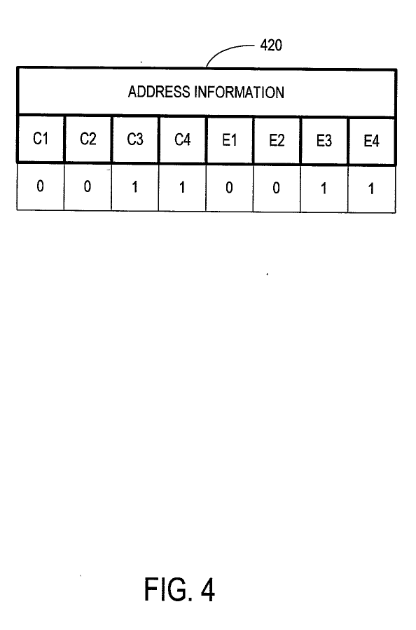

FIG. 3 is a block diagram of a switch fabric according to another embodiment. In this case, each of four edge devices 312, 314, 316, 314 (i.e., E1 through E4) are coupled to each of four crossbar devices 322, 324, 326, 328 (i.e., C1 through C4). FIG. 4 illustrates address information 420 according to this embodiment. In particular, the address information 420 illustrated in FIG. 4 indicates that an associated information packet should be transmitted to C3, C4, E3, and E4 (and not to C1, C2, E1, or E2).

Address Generation and Edge Device

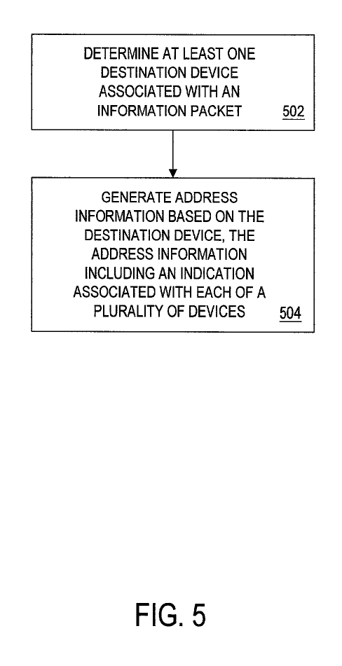

FIG. 5 is a flow chart of a method to generate address information that may be performed, for example, by any of the edge devices shown in FIGS. 1 or 3 according to some embodiments. The flow charts in FIG. 5 and the other figures described herein do not imply a fixed order to the steps, and embodiments,may be practiced in any order that is practicable.

At 502, at least one destination device is determined for an information packet that will be provided through a switch fabric having a plurality of devices (e.g., edge devices and/or crossbar devices). The determination may be based on information received from an entity, and the destination device might be, for example, another edge device or a crossbar device that needs to receive the information packet. Note that a plurality of destination devices may be determined at 502.

At 504, address information is generated for the information packet based on the destination device, the address information including an indication associated with each of the plurality of devices (e.g., a separate indication is provided for a number of different devices in the switch fabric). These indications may comprise a destination device bit map that indicates which of the devices should receive the information packet (e.g., a “1” may indicate that the device should receive the information packet and a “0” may indicate that the device should not receive the information packet).

The information packet may then be transmitted using the address information as a header (e.g., an edge device might transmit the information packet to a crossbar device using a destination device bit map as a header).

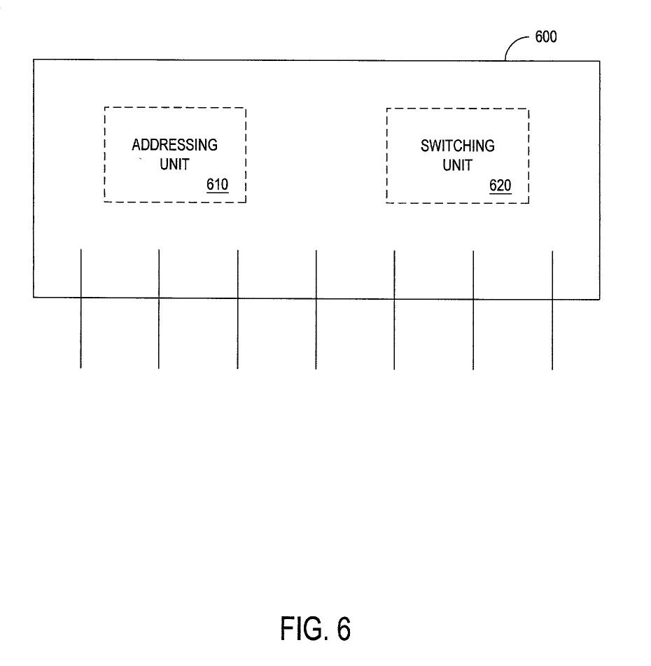

FIG. 6 is a block diagram of an edge device 600 that may perform the method illustrated in FIG. 5 according to some embodiments. The edge device 600 may include hardware and/or software adapted to receive and provide information packets through ports. For example, the edge device 600 might receive an information packet through an input port and provide the information packet and associated address information through an output port.

The edge device 600 may be associated with a processor or an Application-Specific Integrated Circuit (ASIC) designed for a particular transmission protocol. Note that the edge device 600 may also incorporate a storage device, including combinations of magnetic storage devices (e.g., magnetic tape and hard disk drives), optical storage devices, and/or semiconductor memory devices such as Random Access Memory (RAM) devices and Read Only Memory (ROM) devices. The storage device may, for example, store a program for controlling the edge device 600. According to one embodiment, the edge device 600 comprises an INTEL® EXPRESS 500 Series device for a Fast Ethernet network.

The edge device 600 may include an address unit 610 that is adapted to generate address information for an information packet such that the address information includes independent indications for each of a plurality of devices in the switch fabric (e.g., a destination device bit map that reflects which devices in the switch fabric need to receive the information packet).

As used herein, information may be “received” by or “provided” to a software application or module within the edge device 600 from: (i) a crossbar device, (ii) an entity, (iii) another software application or module within the edge device 600, or (iv) any other source.

Information Packets and Crossbar Device

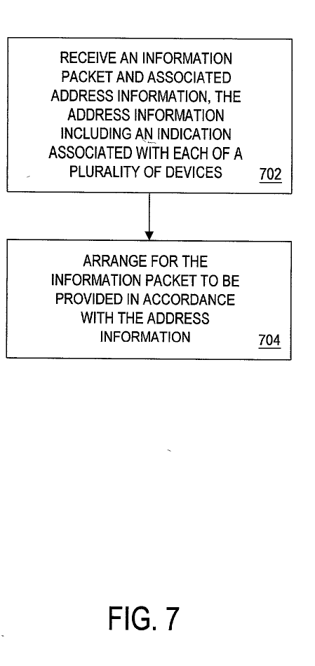

FIG. 7 is a flow chart of a method to provide information packets that may be performed, for example, by any of the edge devices or crossbar devices shown in FIGS. 1 or 3 according to some embodiments. At 702, an information packet and associated address information are received. The address information includes an indication associated with each of a plurality of devices that might receive the information packet (e.g., devices associated with a switch fabric).

At 704, it is arranged for the information packet to be provided in accordance with the address information. For example, the address information may be a destination device bit map that shows which devices should receive the information packet. In this case, the information packet may be forwarded to the appropriate devices based on the bit map.

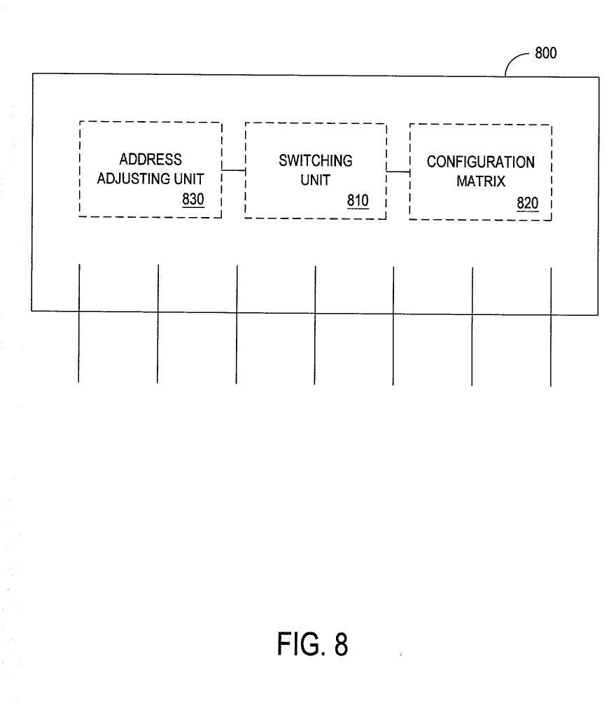

FIG. 8 is a block diagram of a crossbar device 800 that may perform the method illustrated in FIG. 7 according to some embodiments. According to another embodiment, the method is instead performed by a switching unit 620 in an edge device 600.

The crossbar device 800 may include hardware and/or software adapted to receive and provide information through ports. For example, the crossbar device 800 may receive an information packet and associated address information through an input port and provide the information packet through an output port.

The crossbar device 800 may be associated with a processor or an ASIC designed for a particular transmission protocol and may incorporate a storage device. The storage device may, for example, store a program for controlling the crossbar device 800. According to one embodiment, the crossbar device 800 comprises an INTEL® EXPRESS 500 Series device for a Fast Ethernet network.

As used herein, information may be “received” by or “provided” to a software application or module within the crossbar device 800 from: (i) another crossbar device, (ii) an edge device, (iii) another software application or module within the crossbar device 800, or (iv) any other source.

The crossbar device 800 may include a switching unit 810 that is adapted to provide an information packet based on address information (e.g., a destination device bit map indicating which devices should receive the information packet).

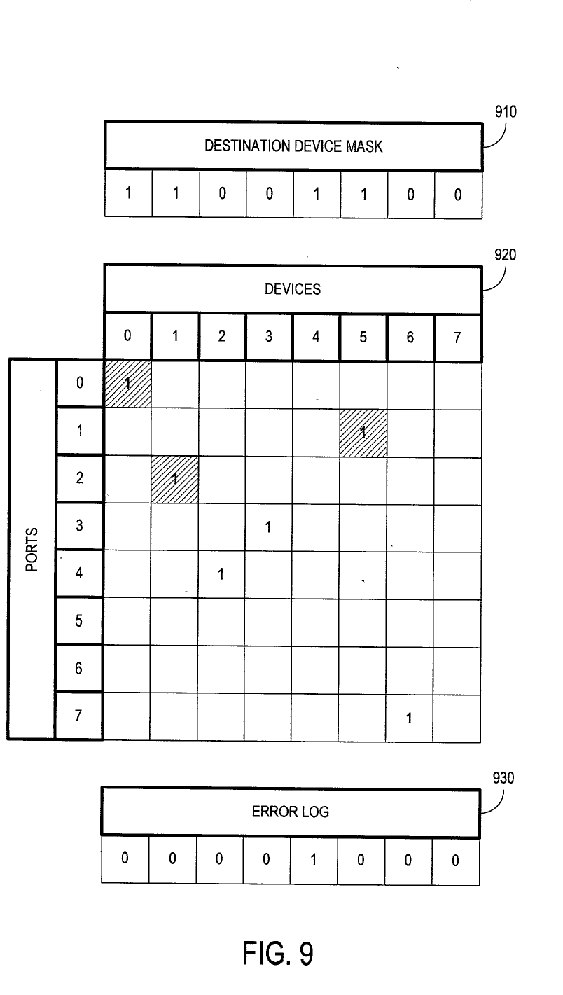

For example, the crossbar device 800 might select one or more ports through which the information packet will be provided based on a configuration matrix 820. An example of a matrix that may be used in connection with the crossbar device 800 will now be described in detail with respect to FIG. 9. The illustration and accompanying description of the matrix presented herein is exemplary, and any number of other arrangements could be employed besides those suggested by the figure.

Configuration Matrix

FIG. 9 illustrates a configuration matrix 920 according to some embodiments. For each of a number of ports, the configuration matrix 920 indicates which devices can be accessed through that port. For example, for each of eight ports (i.e., “0” through “7”) the configuration matrix 920 in FIG. 9 indicates which of eight devices (i.e., “0” through “7”) can be accessed through that port (with a “1” indicating that the device can be accessed and a “0” indicating that the device cannot be accessed). For example, the configuration matrix in 920 indicates that device “2” can be accessed through port “4” and device “6” can be accessed through port “7.”

Consider also the destination device mask 910, which may be based on address information associated with an information packet. Based on the destination device mask 910 shown in FIG. 9, the information packet should be provided to devices “0,” “1,” “4,” and “5.” The devices may correspond to, for example, edge devices and crossbar devices in the switch fabric.

The crossbar device 800 may use destination device mask 910 and the configuration matrix 920 to determine the ports through which an information packet will be transmitted. That is, for each “1” in the destination device mask 910, the crossbar device may scan down the corresponding column in the configuration matrix 920 to locate and select a “1” (as indicated by cross-hatching in FIG. 9). If no “1” was located in the corresponding column, an indication can be placed in an error log 930. That is, the process has not figured out how the information can be provided to a device (e.g., and further processing might need to be performed or an error signal might be generated).

The information packet can then be provided through the ports (i.e., rows) that have at least one selected “1” (i.e., ports “0,” “1,” and “2” in FIG. 9).

Address Information Adjustment

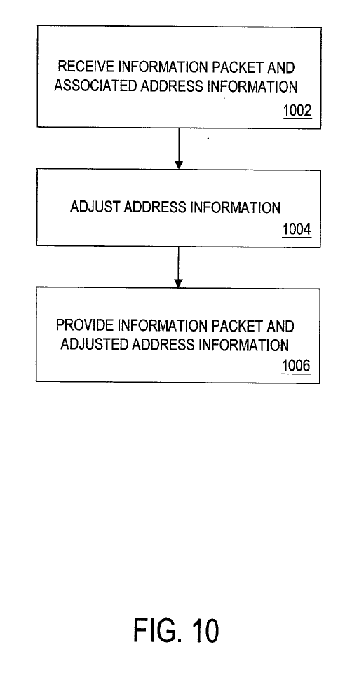

FIG. 10 is a flow chart of a method to adjust address information that may be performed, for example, by any of the crossbar devices shown in FIGS. 1 or 3 according to some embodiments.

At 1002, an information packet is received along with associated address information (including an indication associated with each of a plurality of devices in a switch fabric). At 1004, the address information is adjusted, and the information packet and adjusted address information are provided at 1006 (e.g., by transmitting the information packet and adjusted address information through a port).

Consider address information that includes a destination device bit. The destination device bit map may have a number of bits set to “1” that define destination set of devices. In this case, when the information packet is independently being provided to a subset of the destination set through a first port, the destination device bit map can be adjusted exclude that subset when it is provided through second port.

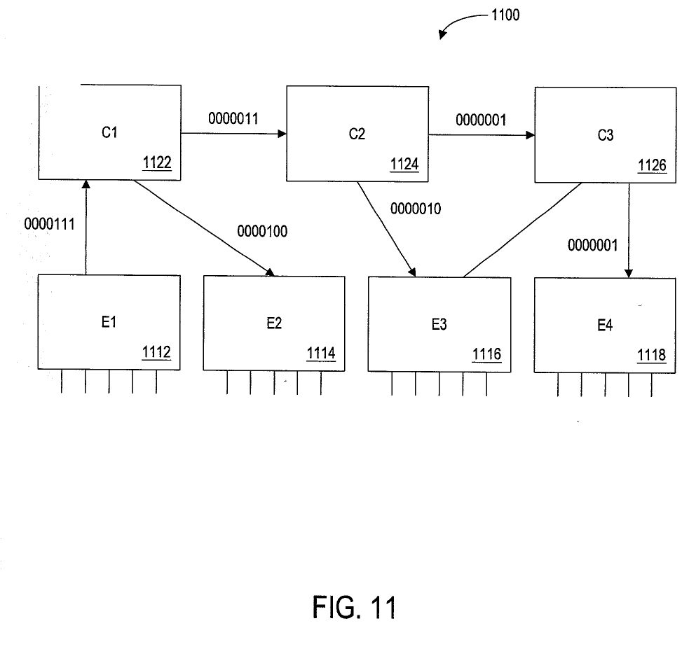

By way of example, FIG. 11 illustrates a switch fabric topology 1100 in accordance with some embodiments. The topology 1100 includes four edge devices 1112, 1114, 1116, 1118 and three crossbar devices 1122, 1124, 1126. The first edge device 1112 (“E1”) determines that an information packet must be provided to the second edge device 1114 (“E2”), the third edge device 1116 (“E3”), and the fourth edge device 1118 (“E4”). Moreover the address information comprises a destination device bit map arranged as follows: C1, C2, C3, E1, E2, E3, E4. As a result, E1 transmits a destination device bit map of “0000111” to C1 (i.e., indicating that the information packet should be provided to E2, E3, and E4).

After C1 receives the information packet and destination device bit map, it determines that the information packet should be output through two ports (i.e., through a first port to E2 and a second port to C2 for eventual delivery to E3 and E4).

In accordance with this embodiment, C1 adjusts the destination device bit map before the information packet is provided via the two ports. In particular, the destination device bit map is adjusted to reflect only those devices associated with each port.

For example, the adjusted destination device bit map sent from C1 to C2 is “0000011.” In other words, it no longer indicates that the information packet should be provided to E2—because C1 is independently providing the information packet to E2 (and thus C2, and later devices, do not need to take any further action with respect to E2). Similarly, the C2 changes the destination device bit map to “0000001” before sending it to C3. In this way, C3 recognizes that it should send the information packet to E4 (and that it does not need to send the information packet to E3).

Such adjustments to the address information may be performed, for example, by an address adjusting unit 830 associated with the crossbar device 800 shown in FIG. 8. By modified headers as an information packet cascades through a switch fabric, implementations associated with multi-level and/or redundant topologies may be simplified. Moreover, memory and logic requirements for crossbar devices may be reduced.

Port Selection

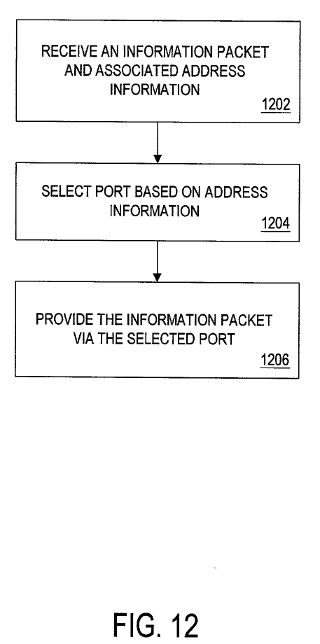

FIG. 12 is a flow chart of a method to select a port according to some embodiments. The method may be performed, for example, by an address adjusting unit 830 in a crossbar device 830. At 1202, an information packet is received along with associated address information (including indications for a number of devices in a switch fabric). At 1204, a port is selected based on the address information, and the information packet is provided via the selected port at 1206.

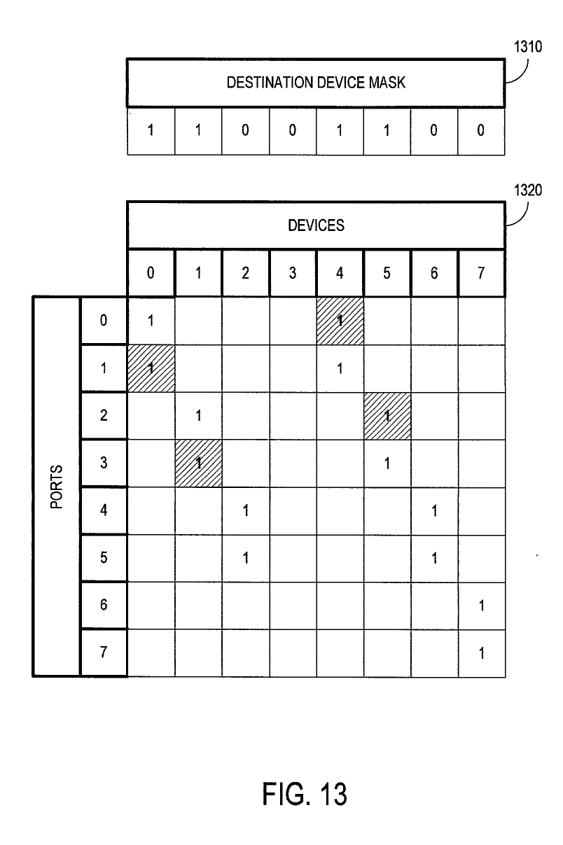

Consider FIG. 13, which illustrates a configuration matrix 1320 that is not being used in accordance with this embodiment. For each of a number of ports, the configuration matrix 1320 indicates which devices can be accessed via that particular port. For example, for each of eight ports (i.e., “0” through “7”) the configuration matrix 1320 indicates which of eight devices (i.e., “0” through “7”) can be accessed through that port (with a “1” indicating that the device can be accessed and a “0” indicating that the device cannot be accessed). Note that single device may be accessed through multiple ports (e.g., for redundancy). For example, device “2” can be accessed through port “4” and/or port “5.” Also note that a single port may be used to access multiple devices. For example, port “5” may be used to access device“2” and/or device “6.”

Consider also the destination device mask 1310, which may be based on address information that is associated with an information packet. Based on the destination device mask 1310, the information packet should be provided to devices “0,” “1,” “4,” and “5.” The devices may correspond to, for example, edge devices and crossbar devices in the switch fabric.

The crossbar device then uses the configuration matrix 1320 to determine the ports through which the information packet should be transmitted. That is, for each bit set to “1” in the destination device mask 1310, the crossbar device scans down the corresponding column in the configuration matrix 1320 to locate and select a “1” (as indicated by cross-hatching in FIG. 13). The information packet is then provided through the ports (i.e., rows) that have at least one selected “1” (i.e., ports “0,” “1,” “2,” and “3” in FIG. 13).

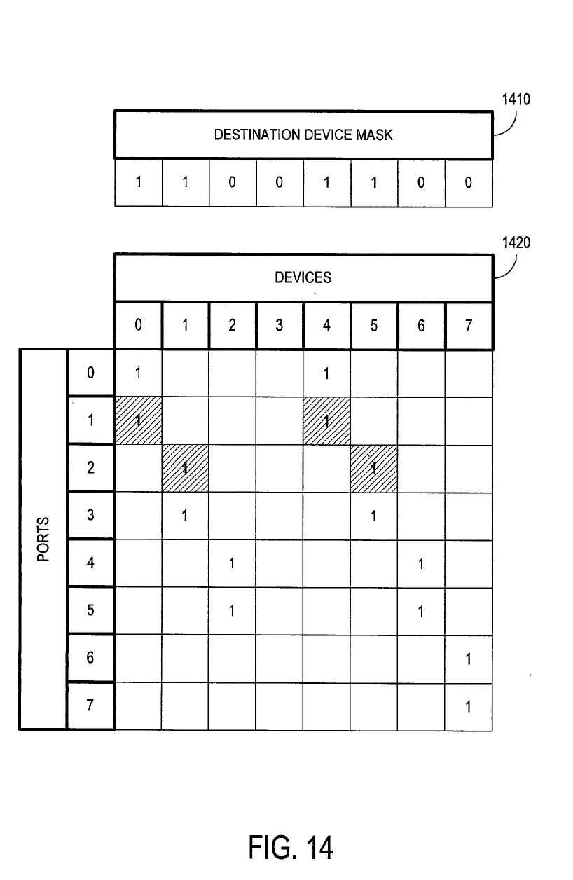

Now consider FIG. 14, which illustrates a configuration matrix 1420 that is being used in accordance with this embodiment. Note that the destination device mask 1410 and the configuration of the crossbar device are identical to those described with respect to FIG. 13.

In this case, however, the crossbar device has selected different ports to be used when providing the information packet. In particular, the crossbar device is able to send the information packet to the four devices ( i.e., “0,” “1,” “4,” and “5”) using only two (and not four) ports. That is, port “1” is used to access devices “0” and “4” and port “2” is used to access devices “1” and “5.” As a result, the selected ports in FIG. 14 use only half of the bandwidth as compared to the selected ports in FIG. 13 while achieving the same result.

Referring again to FIG. 12, the address information may be a destination device bit map reflecting that an information packet is destined for a plurality of destination devices. In this case, the selection at 1204 may comprise selecting a port for one destination device (i.e., from a plurality of available ports) based on at least one other destination device.

The selection may, in effect, distinguish between the accessibility of a device and the equivalence of ports or links used to reach the device. The accessibility information is used to determine a set of links that could potentially be used to reach a device (e.g., a link aggregate). The link equivalence information is then used to determine the physical link that will be used to transmit the information packet.

The selection may be performed using, for example, an optimization process or algorithm and/or weight information (e.g., an algorithm might indicate that a first port should be selected seventy five percent of the time while a second port should be selected twenty five percent of the time). Such an approach can improve the bandwidth capability of a crossbar device, increase the availability of stacked systems, simplify switch fabric management logic, and reduce memory and logic requirements for a crossbar device (e.g., especially when implementing multi-level and/or redundant topologies).

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above-described apparatus and methods to accommodate these and other embodiments and applications.

Although some embodiments described herein are directed to Fast Ethernet networks, embodiments may be associated with other types of networks. For example, a destination device bit map may be used with another type of Ethernet network (e.g., a Gigabit Ethernet network) or a wireless network. Similarly, although particular switch fabric configurations have been described herein, embodiments may be associated with other switch fabric configurations.

The several embodiments described herein are solely for the purpose of illustration. Persons skilled in the art will recognize from this description that other embodiments may be practiced with modifications and alterations limited only by the claims.

What is claimed is:

1. A method of facilitating delivery of information packets via a switch fabric associated with a plurality of devices, comprising:
determining a destination device associated with an information packet; and
generating address information for the information packet based on the destination device, the address information including an indication associated with each of the plurality of devices.

2. The method of claim 1, wherein the indications comprise a destination device bit map indicating which of the plurality of devices should receive the information packet.

3. The method of claim 1, further comprising:
transmitting the information packet in association with the address information.

4. The method of claim 3, wherein said transmitting comprises:
transmitting the information packet with the address information as a header.

5. The method of claim 3, wherein said transmitting comprises:
transmitting the information packet at least one of: (i) at a predetermined offset with respect to the information packet, and (ii) at a predetermined position with respect to the information packet.

6. The method of claim 1, wherein said generating is performed by an addressing unit associated with an edge device having a plurality of ports.

7. The method of claim 1, wherein the plurality of devices include at least one of: (i) an edge device, (ii) a crossbar device, (iii) an addressable entity, (iv) a single-level topology, (v) a multi-level topology, (vi) a stacked topology, and (vii) a star-wired topology.

8. The method of claim 1, wherein the switch fabric is associated with at least one of: (i) a Fast Ethernet network, (ii) a fiber network, (iii) a local area network, (iv) a virtual local area network, and (v) an Internet packet network.

9. An apparatus, comprising:
an input port adapted to receive an information packet; and
an addressing unit coupled to said input port and adapted to generate address information for the information packet based on an associated destination device, the address information including an indication associated with each of a plurality of devices.

10. The apparatus of claim 9, wherein the indications comprise a destination device bit map indicating which of the plurality of devices should receive the information packet.

11. The apparatus of claim 9, further comprising:
an output port coupled to the addressing unit and adapted to provide the information packet an d address information.

12. The apparatus of claim 9, wherein the apparatus comprises an edge device.

13. A medium storing instructions adapted to be executed by a processor to perform a method of facilitating delivery of information packets via a switch fabric associated with a plurality of devices, said method comprising:
determining a destination device associated with an information packet; and
generating address information for the information packet based on the destination device, the address information including an indication associated with each of the plurality of devices.

14. The medium of claim 13, wherein the indications comprise a destination device bit map indicating which of the plurality of devices should receive the information packet.

15. A method of facilitating delivery of information packets via a switch fabric associated with a plurality of devices, comprising:
receiving an information packet and associated address information, the address information including an indication associated with each of the plurality of devices; and
arranging for the information packet to be provided in accordance with the address information.

16. The method of claim 15, wherein the indications comprise a destination device bit map indicating which of the plurality of devices should receive the information packet.

17. The method of claim 15, wherein said arranging comprises:
forwarding the information packet based on the address information.

18. The method of claim 15, wherein said arranging is performed by a switching unit associated with a crossbar device.

19. The method of claim 15, wherein said arranging is performed by an edge device.

20. The method of claim 15, wherein the plurality of devices include at least one of: (i) an edge device, (ii) a crossbar device, (iii) an addressable entity, (iv) a single-level topology, (v) a multi-level topology, (vi) a stacked topology, and (vii) a star-wired topology.

21. The method of claim 15, further comprising:
adjusting the address information,
wherein said arranging comprises providing the information packet and the adjusted address information.

22. The method of claim 15, wherein said arranging comprises:
selecting a port in accordance with the address information; and
transmitting the information packet via the selected port.

23. The method of claim 22, wherein said selecting is further based on at least one of: (i) a plurality of destination devices; (ii) a configuration matrix, and (iii) an optimization process.

24. An apparatus, comprising:
an input port adapted to receive an information packet and associated address information, the address information including an indication associated with each of a plurality of devices; and
a switching unit coupled to said input port and adapted to provide the information packet in accordance with the address information.

25. The apparatus of claim 24, wherein the indications comprise a destination device bit map indicating which of the plurality of devices should receive the information packet.

26. The apparatus of claim 24, further comprising:
an output port coupled to the switching unit and adapted to provide the information packet.

27. The apparatus of claim 24, wherein the apparatus comprises at least one of: (i) an edge device and (ii) a crossbar device.

28. A medium storing instructions adapted to be executed by a processor to perform a method of facilitating delivery of information packets via a switch fabric associated with a plurality of devices, said method comprising:
receiving an information packet and associated address information, the address information including an indication associated with each of the plurality of devices; and
arranging for the information packet to be provided in accordance with the address information.

29. The medium of claim 28, wherein the indications comprise a destination device bit map indicating which of the plurality of devices should receive the information packet.

30. A method of facilitating delivery of information packets via a switch fabric associated with a plurality of devices, comprising:
receiving an information packet and associated address information, the address including an indication associated with each of the plurality of devices;
adjusting the address information; and
providing the information packet and the adjusted address information.

31. The method of claim 30, wherein the indications comprise a destination device bit map indicating which of the plurality of devices should receive the information packet reflecting that the information packet is destined for a destination set of devices.

32. The method of claim 31, wherein the information packet is independently provided to a subset of the destination set, and the adjusted destination device bit map excludes the subset.

33. The method of claim 30, wherein said providing comprises:
transmitting the information packet in accordance with the adjusted address information.

34. The method of claim 30, wherein said arranging is performed by an address adjusting unit associated with a crossbar device.

35. The method of claim 30, wherein the plurality of devices include at least one of: (i) an edge device, (ii) a crossbar device, (iii) an addressable entity, (iv) a single-level topology, (v) a multi-level topology, (vi) a stacked topology, and (vii) a star-wired topology.

36. The method of claim 35, wherein said arranging comprises:
selecting a port in accordance with the adjusted address information; and
transmitting the information packet via the selected port.

37. The method of claim 36, wherein said selecting is further based on at least one of: (i) a plurality of destination devices; (ii) a configuration matrix, and (iii) an optimization process.

38. An apparatus, comprising:
an input port adapted to receive an information packet and associated address information, the address information including an indication associated with each of a plurality of devices; and
an address adjusting unit coupled to said input port and adapted to adjust the address information.

39. The apparatus of claim 38, wherein the indications comprise a destination device bit map indicating which of the plurality of devices should receive the information packet.

40. The apparatus of claim 38, further comprising:
an output port adapted to provide the information packet and adjusted address information.

41. The apparatus of claim 38, wherein the apparatus comprises a crossbar device.

42. A medium storing instructions adapted to be executed by a processor to perform a method of facilitating delivery of information packets via a switch fabric associated with a plurality of devices, said method comprising:
receiving an information packet and associated address information, the address including an indication associated with each of the plurality of devices;
adjusting the address information; and
providing the information packet and the adjusted address information.

43. The medium of claim 42, wherein the indications comprise a destination device bit map indicating which of the plurality of devices should receive the information packet.

44. A method of facilitating delivery of information packets via a switch fabric associated with a plurality of devices, comprising:
receiving an information packet and associated address information, the address information including an indication associated with each of the plurality of devices;
selecting a port based on the address information; and
providing the information packet via the selected port.

45. The method of claim 44, wherein the indications comprise a destination device bit map reflecting that the information packet is destined for a plurality of destination devices.

46. The method of claim 45, wherein said selecting comprising selecting a port for a destination device from a plurality of available ports.

47. The method of claim 46, wherein said selecting is further based on at least one other destination device.

48. The method of claim 46, wherein said selecting is performed using at least one of: (i) a destination device mask, (ii) a configuration matrix, and (iii) an optimization process.

49. The method of claim 48, wherein said selecting is further based on weight information.

50. An apparatus, comprising:
an input port adapted to receive an information packet and associated address information, the address information including an indication associated with each of a plurality of devices; and
a switching unit coupled to said input port and adapted to select a port based on the address information and provide the information packet via the selected port.

51. The apparatus of claim 50, wherein the indications comprise a destination device bit map indicating which of the plurality of devices should receive the information packet.

52. The apparatus of claim 50, wherein the apparatus comprises a crossbar device.

53. A medium storing instructions adapted to be executed by a processor to perform a method of facilitating delivery of information packets via a switch fabric associated with a plurality of devices, said method comprising:
receiving an information packet and associated address information, the address information including an indication associated with each of the plurality of devices;
selecting a port based on the address information; and
providing the information packet via the selected port.

54. The medium of claim 53, wherein the indications comprise a destination device bit map indicating which of the plurality of devices should receive the information packet.

55. A computer implemented method of facilitating delivery of information packets via a switch fabric associated with a plurality of devices, comprising:
receiving an information packet and associated address information, the address information including a destination device bit map indicating which of the plurality of devices should receive the information packet;
selecting a port in accordance with the destination device bit map, a configuration matrix, and an optimization process;
adjusting the address information; and
transmitting the information packet and the adjusted address information via the selected port.

56. The method of claim 55, wherein said receiving, selecting, adjusting, and transmitting are performed by an Ethernet crossbar device.

57. A switch fabric system, comprising:
an edge device, comprising:
an edge input port adapted to receive an information packet,
an addressing unit coupled to said edge input port and adapted to generate address information based on a destination device associated with an information packet, the address information including an indication associated with each of a plurality of devices, and
an edge output port coupled to the addressing unit and adapted to provide the information packet and address information; and
a crossbar device, comprising:
a crossbar input port coupled to said edge output port and adapted to receive the information packet and associated address information, and
a switching unit coupled to said crossbar input port and adapted to provide the information packet in accordance with the address information.

58. The system of claim 57, wherein the indications comprise a destination device bit map indicating which of the plurality of devices should receive the information packet.
